(19) United States
(12) Patent Application Publication
(10) Pub. No.: US 2019/0180208 A1
(43) Pub. Date: Jun. 13, 2019

(54) COMPUTER-IMPLEMENTED SYSTEM AND METHOD FOR IMPLEMENTING EVIDENCE-BASED PRACTICES FOR SOCIAL RESOURCE PLANNING, ALLOCATION AND MANAGEMENT

(71) Applicant: tuliptree systems, LLC, Houston, TX (US)

(72) Inventors: LaRon E. Nelson, Pittsford, NY (US); Kristaps T. Dzonsons, Newberry, FL (US)

(73) Assignee: tuliptree systems, LLC, Houston, TX (US)

(21) Appl. No.: 16/214,704

(22) Filed: Dec. 10, 2018

Related U.S. Application Data
(60) Provisional application No. 62/596,877, filed on Dec. 10, 2017.

(51) Int. Cl. G06Q 10/06; G06F 16/93; G06F 16/22; G06F 21/60; G06Q 50/00

(52) U.S. Cl. CPC G06Q 10/0635; G06F 16/93; G06Q 50/01; G06F 21/602; G06F 16/22

(57) ABSTRACT

A method for facilitating competence support for a client to meet a goal of the client is provided. The method includes providing a risk assessment template; allowing for the selection of one of a plurality of structured answers for each of the structured set of questions in the risk assessment template using client information to provide a risk assessment document; generating a client risk score based upon at least one of the selected structured answers; determining that the client should be provided a referral to at least one receiver based on the generated client risk score; and allowing for the communication of the referral from the coordinator computing device to a receiver computing device associated with the at least one receiver, wherein the at least one receiver is associated with at least one risk category. A system for implementing the above-referenced method is provided, along with other methods.

### CROSS-REFERENCE TO RELATED APPLICATIONS

This application claims the benefit of U.S. Patent Application No. 62/596,877, filed on Dec. 10, 2017, the contents of which are incorporated by reference in its entirety.

### FIELD OF THE INVENTION

The present invention relates to a computer-implemented system and method for implementing evidence-based practices (EBP) for social resource planning, allocation and management; in particular, a system and method that may be implemented in the form of a network-based software platform that is used to leverage social resources, such as networks, ties, and related structures of individuals and institutions, embedded within the fields of health care, education, criminal justice, and/or social services to improve the efficacy of such services for the betterment of the quality-of-life, starting with the individual, with the view of improving the overall well-being of society. Other aspects of the system and method are also provided.

### BACKGROUND OF THE INVENTION

Social resource networks and related structures are provided by the government, private and non-profit organizations across a wide range of areas that aim to aid individuals and groups to improve their quality of life and better our society as a whole. While the intent of the organizations within these networks and structures is to provide the relevant services in the most effective manner possible, there are inefficiencies in the current construct that limit the amount of positive results that can be obtained. For instance, when a person is seeking assistance with a metal health condition, the current system provides the individual with a coordinator that must manually try to search and locate an appropriate receiver to assist with the person's condition. Once a receiver is located, the coordinator does not typically have any further contact with the person to track his or her progress or follow up to provide additional services that may be needed. Further, once a receiver places the person in a program to assist with the mental illness, there is no efficient mechanism to allow the person to self-track his or her progress, or communicate any observed conditions with the receiver in an anonymous, private manner to more efficiently treat the condition.

As such, there is a need for a system and method that will address one or more of the above-referenced drawbacks. The present invention addresses these needs as well as other needs.

### BRIEF SUMMARY OF THE INVENTION

As will be described in more detail below, one aspect of the present invention provides a computer-based social resource system and method that allows a client to efficiently and dynamically connect a client with the appropriate social resources necessary to address or otherwise achieve a goal in a given risk category, while allowing the client to maintain anonymity. For example, a method is provided to facilitate competence support for a client to meet a goal of the client. Utilizing a processor the method comprises the steps of: providing a risk assessment template stored in a memory, wherein the risk assessment template includes a structured set of questions, wherein each of the structured set of questions includes a plurality of structured answers, and wherein the structured set of questions correspond to at least one risk category; allowing for the selection of one of the plurality of structured answers for each of the structured set of questions in the risk assessment template using client information to provide a risk assessment document, wherein the selection of the one of the plurality of structured answers is provided by at least one of a coordinator computing device; generating a client risk score based upon at least one of the selected structured answers provided for the structured set of questions included in the risk assessment document; utilizing reduction algorithm to determine that the client should be provided a referral to at least one receiver based on the generated client risk score; and allowing for the communication of the referral from the coordinator computing device to a receiver computing device associated with the at least one receiver, wherein the at least one receiver is associated with the at least one risk category.

In other aspects of the above-referenced method, the risk assessment template may be fixed and stored in the memory of at least one of the coordinator computing device or a server in communication with the coordinator computing device over a network. Further, the plurality of structured answers may be at least one of a numerical range, a numerical input, a defined value, a word, or a phrase, and may be mapped to an ordered set of values that are arranged in unit intervals. Also, at least one of the structured set of questions may correspond to a plurality of different risk categories, wherein the unit intervals are correlated across the plurality of different risk categories such as, but not limited to, mental health, sexual health (e.g., pre-exposure prophylaxis (PrEP) adherence), general health, general medical, housing conditions, living and accommodation, employment, finances, transportation, substance abuse (e.g., drugs), injection behavior (e.g., drugs), isolation and social status, legal issues. The method may also include the step of determining that the client should be provided a referral to at least one receiver when the client risk score is above a predetermined threshold, or such determination may be based on the highest client risk score included in the risk assessment document. The method may further include the step of allowing for the coordinator computing device to be used to acknowledge acceptance of referral from receiver computing device. Also, the step of identifying the at least one receiver included in the referral may be based on at least one of geographic location, capacity, facilities, and historical trends of the at least one receiver. The risk assessment document may be read-only and stored in a memory of a server in communication with the coordinator computing device over a network. The method may further include the steps of: generating a hash value utilizing a data representation of the selected one of the plurality of structured answers for each of the structured set of questions, the generated client risk score, and the referral; communicating the hash value to a client computing device; and storing the hash value in a memory of the client computing device.

In another aspect, the present invention may include a system and method for allowing a client to communicate with a coordinator while participating in a support service provided by a receiver to provide ongoing feedback that may result a change in the referral that was previously provided by the coordinator. As such, the system and method provides a mechanism for dynamically changing a referral to reflect the current state of a client's needs and goals. For example, a method is provided to facilitate and support communication between a client and a coordinator within a social network. The method utilizes a processor to perform the following steps: providing a client computing device associated with a client; providing a coordinator computing device associated with a coordinator, wherein the coordinator computing device includes a memory and is in communication with the client computing device over a network, wherein the coordinator computing device is utilized to create an initial risk assessment document using client risk assessment information, wherein the initial risk assessment document is stored in a memory of a server in communication with the coordinator computing device over the network, and wherein the initial risk assessment document is used to generate a referral including an identification of at least one receiver; utilizing the client computing device to generate a log record, wherein the log record includes at least one of updated client risk assessment information or a request to communicate with the coordinator computing device; providing the coordinating computing device with access to the log record over the network; and allowing for the generation of an updated risk assessment document by the coordinator computing device based at least in part on the log record, wherein the updated risk assessment document is stored in the memory of the server, and wherein the updated risk assessment document is utilized to modify the referral.

In the above method, the memory of the server may include an encrypted partition, and the initial risk assessment document may be stored in a database in the encrypted partition. Further, the memory of the server may include an encrypted partition, wherein the updated risk assessment document is stored in a database in the encrypted partition. The storing of the initial risk assessment document in the memory of the server as described above may include: providing the initial risk assessment document in a database; encrypting the database; and storing the database in the memory of the server. Also, the modification of the referral may include adding one or more receivers to the identification of the at least one receiver, and/or removing receiver(s) from the referral. The method may further comprise the step of storing the log record in the memory of the server prior to the step of providing the coordinating computing device with access to the log record.

In still another aspect, the present invention may also provide a system and method for allowing for the secure tracking of ongoing log data that could be beneficial in allowing the client to assess patterns and trends occurring during the course of a service plan being provided by a receiver. The system and method also allows for the anonymous communication of the log data to the receiver for further tracking and analysis for assessing current and future services being provided to the client. For example, a method is provided to allow for anonymous and private communication of log data associated with a risk assessment from a client to a receiver in the context of evidence-based practices. The method comprises the steps of: providing a risk assessment template stored in a memory; allowing the risk assessment template to be completed using client information entered using a coordinator computing device, wherein the completed risk assessment template is a risk assessment document stored in a memory of a server, wherein the server is in communication with the coordinator computing device over a network; associating a client with a receiver based on the risk assessment document, wherein the client is associated with a client computing device; allowing the client to enter log data into a log using the client computing device, wherein the log data is related to information contained the risk assessment document; allowing for the display of the log data on a display of the client computing system; associating the log with a receiver computing device, wherein the receiver computing device is associated with the receiver; encrypting the log data using the client computing device; communicating the encrypted log data and hashed client registration information from the client computing device to the server over the network, wherein the encrypted log data and hashed client registration information is stored in the memory of the server; and allowing the client computing device to selectively permit at least a portion of the encrypted log data to be decrypted and displayed on a display of the receiver computing device.

In the above method, the risk assessment template may be fixed and stored in the memory of the server. Also, the encrypted log data may stored in a memory of the client computing device, and the log data may be structured log data. The log data may be at least one of a log message or a log event.

In other aspects of the present invention, a system and computer-readable medium may be provided to perform the steps in each of the methods described in the present patent application.

Additional objects, advantages and novel features of the present invention will be set forth in part in the description which follows, and will in part become apparent to those in the practice of the invention, when considered with the attached figures.

### BRIEF DESCRIPTION OF THE DRAWINGS

The accompanying drawings form a part of this specification and are to be read in conjunction therewith, wherein like reference numerals are employed to indicate like parts in the various views, and wherein:

FIG. 1 is a schematic drawing showing components of the theory-based intervention model work together;

FIG. 2 is a schematic drawing similar to FIG. 1 showing additional ways that people can interact with the theory-based intervention model;

FIG. 3 is a table showing distribution of motivational nutriments operationalized to comprehensive risk assessment;

FIG. 4 is a table showing distribution of motivational nutriments operationalized to behavioral counseling;

FIG. 5 is a table showing distribution of motivational nutriments operationalized to action planning;

FIG. 6 is a table showing distribution of motivational nutriments operationalized to care coordination;

FIG. 7 is a table showing distribution of motivational nutriments operationalized to self-monitoring;

FIG. 8 is a table showing distribution of motivational nutriments operationalized to peer support;

FIG. 9 is a general systematic flow chart illustrating the interactions between components that may interact with a system in accordance with the present invention;

FIG. 10 is a schematic diagram showing an exemplary networked environment in which the system may be implemented;

FIG. 11 is a general flow chart showing a client's systematic interaction with one embodiment of the system of the present invention;

FIG. 12 is a general flow chart showing the interaction between a request and an application;

FIG. 13 is a flow chart illustrating a method in accordance with an aspect of the present invention;

FIG. 14 is a flow chart illustrating a method in accordance with yet another aspect of the present invention;

FIG. 15 a flow chart illustrating a method in accordance with still another aspect of the present invention; and

FIG. 16 is a block diagram generally illustrating a computing environment in which the invention may be implemented.

### DETAILED DESCRIPTION OF THE INVENTION

In general, the system, tools and methods described herein for implementing evidence-based practices (EBP) (also known as Evidence Based Intervention (EBI)) for social resource planning, allocation and management may be implemented in hardware, software or a combination thereof. In certain aspects, the system and method that may be implemented in the form of a network-based software platform that is used to leverage social resources, such as networks, ties, and related structures of individuals and institutions, embedded within the fields of health care, education, and/or social services to improve the efficacy of such services for the betterment of the quality-of-life, starting with the individual, with the view of improving the overall well-being of society. For instance, the platform may operate to provide an individualized risk assessment based on input from an individual, patient, student, or the like (i.e., client), allow a coordinator to associate the client with one or more agencies that are capable of providing the client with services that address or relate to items or findings associated with the risk assessment, and allow the coordinator, agencies, and/or client to continuously change, address, and confidentially track the services being provided risk as they relate to the assessment items or findings.

The EBP can be described as a theory-based intervention model that operates to assist a client with achieving a particular goal. The exemplary theory-based intervention model described herein is known as Client-Centered Care Coordination (C4^{SM}). C4^{SM} may be used in any number of fields to assist a client, including, but not limited to health care, education, and/or social services. In one exemplary model, a target goal for a client could be: (1) a behavior (e.g., to take a pill daily); (2) a health status (e.g., decrease in HIV viral load, reduction in blood glucose levels); (3) an event (e.g., seronegative HIV test); and/or (4) another yet undefined category. Each of these goals can be categorized as a non-behavioral goal or a behavioral goal. Non-behavioral goals are attained through the enactment of antecedent behaviors that are determined, through available scientific evidence, situation-specific logic(s), and individual-level capacities and preferences that lead to the outcome of interest. Antecedent behaviors are activated through the provision of supports for three motivational nutriments: autonomy, competence and relatedness. Similarly, behavioral goal attainment is facilitated through the provision of supports for the same three motivational nutriments.

Competence is directed at providing the resources, skills, and support necessary to facilitate mastery of the client's goal(s). The system embodies competence by pulling, consolidating and centralizing the assessment (data collection), analysis and referral processes, and communicating this with the networked receivers who will use it help organize and provide services that meet the client's needs. The client is more likely to be successful because the complicated maze of referrals has been distilled into one continuous interlocking system and method that creates a service network (as large or as small as it needs to be based on number of risk categories and the magnitude of the risk scores) that can expand and contract based on the client's evolving needs. The system operationalizes competence by facilitating access to services provided by receivers, but it is also operationalizes “relatedness/closeness” because of the establishment of a personalized client-centered network (based on the risk category referrals) from within the larger available network of receiver resources/services. The system further embodies the construct of relatedness/closeness in that it develops a “closeness” with the client. In a sense, the system is getting to the know the client and learning and responding to and predicting preferences. Autonomy is maintained by way of the client's ability reject a referral (altogether) or to reject referral to a specific receiver, and is further maintained by the coordinator's ability to override the referral on behalf of the client. In other words, autonomy is reflected in the client's maintenance of the power (either directly or indirectly via the coordinator) to determine what data to provide, what type of referral to accept, and which receiver will comprise their personalized service network.

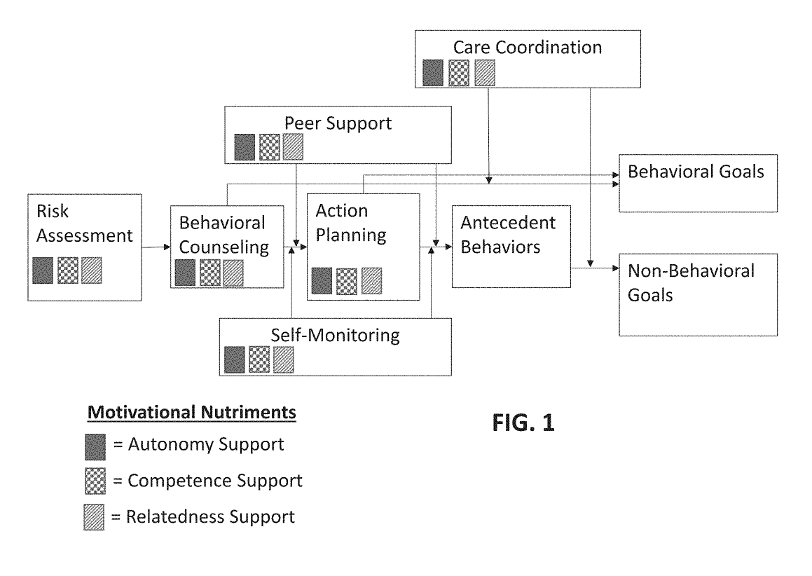

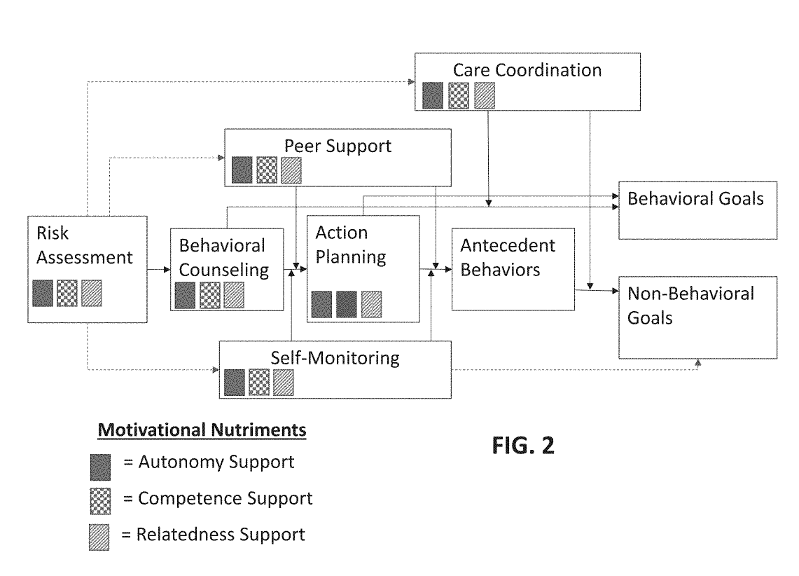

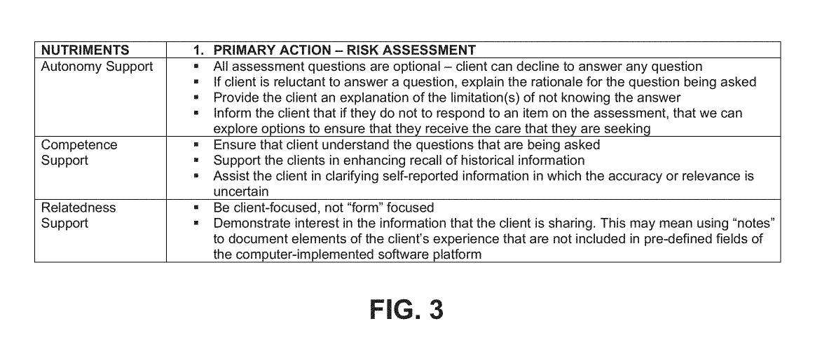

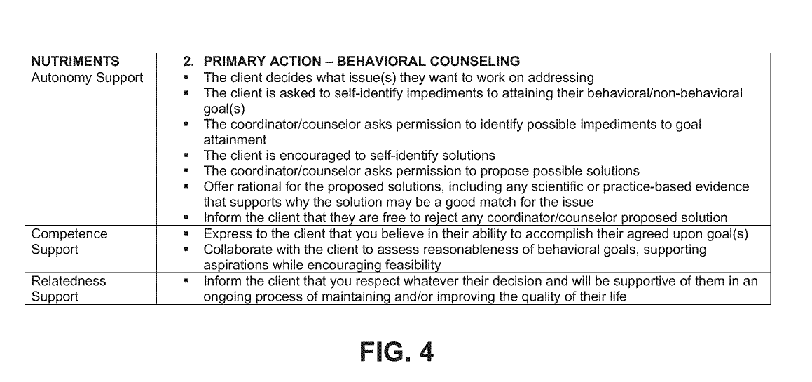

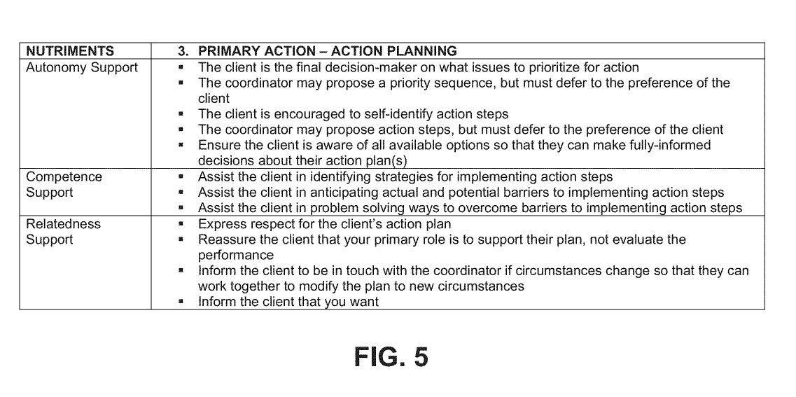

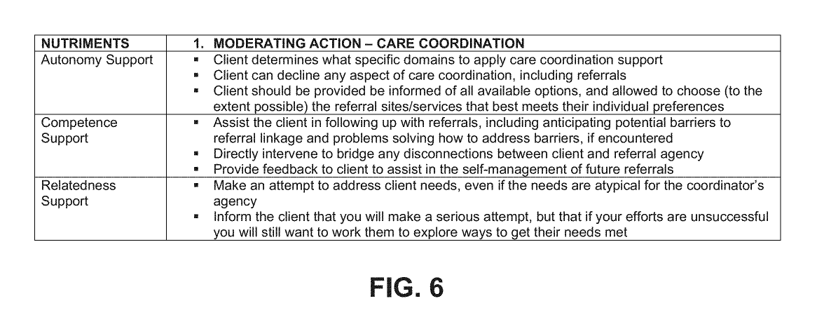

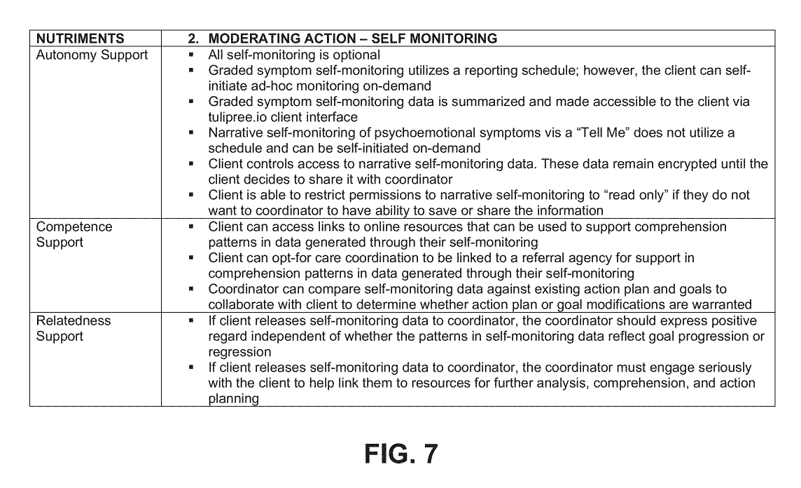

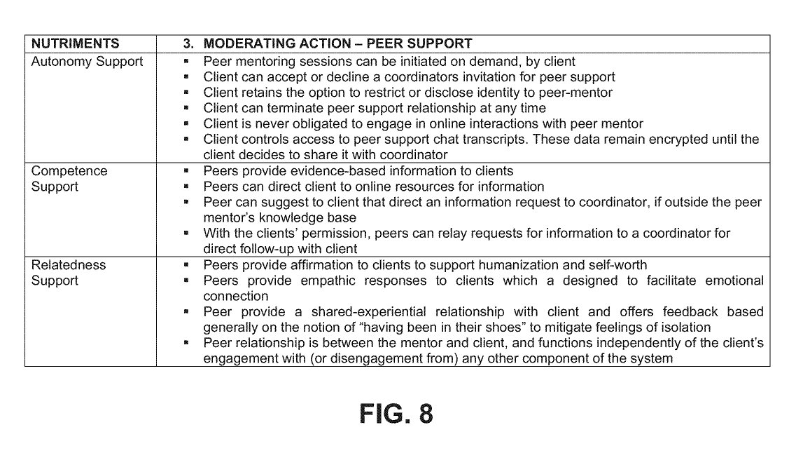

The three nutriments of autonomy, competence and relatedness are theorized to lead to, over time, the endorsement of a target goal and to motivate engagement in (a) targeted goal behavior and (b) antecedent behaviors (when applicable). The three motivational nutriments are derived from self-determination theory, which is the basis of the logic of C4^{SM}. In C4^{SM}, the actions of a provider (e.g., counselor, nurse, coordinator, peer, receiver) to a client are guided by the provision of motivational nutriments. The C4^{SM} model includes six actions, three “primary” and three “moderating” actions. The primary actions include a comprehensive risk assessment, behavioral counseling, and action planning. The moderating actions include care coordination, self-monitoring, and peer support. An exemplary schematic diagram is provided in FIG. 1 to show how these components of C4^{SM} work together. FIG. 2 is another schematic diagram that is similar to FIG. 1 showing additional ways that people can be engaged with the components. The active process in C4^{SM} is in the application of the motivational nutriments to the six actions in the model. FIGS. 3-8 illustrate examples of how the motivational nutriments may be applied under each of the primary and moderating actions.

While the system and methods related to the EBP are described herein may make reference to a social service context, it should be understood that the system and method described can be utilized in any field that uses EBP's, such as, but not limited to, health care, education, and criminal justice. Furthermore, the system and associated methods can be tailored for application towards the care and support of an array of populations with special needs due to physical, mental, and/or socioeconomic factors. They include, but are not limited to, those impacted by health conditions such as HIV/AIDS, substance abuse/addiction, and mental health maladies and other disabling conditions. They also may include areas necessitating specialized social resource allocation and management such as veterans care, care for the homeless, child-welfare support, and elder-care.

In one or more aspects, the system and method described herein utilizes the methodology of C4^{SM} described above to allow for the identification of a client's social needs and target goal(s) by providing a risk assessment, automatically or manually coordinate social services for clients based on results obtained from a risk assessment and a risk category of an identified social need or target goal, allocate the social services, provides member agencies access to client information related to services provided to manage and adjust coordinated services (if necessary), and allow clients to track their own progress (e.g., behaviors, medication, feelings, etc.) as they are working toward attaining a goal, which the client can choose to share with a member agency if desired.

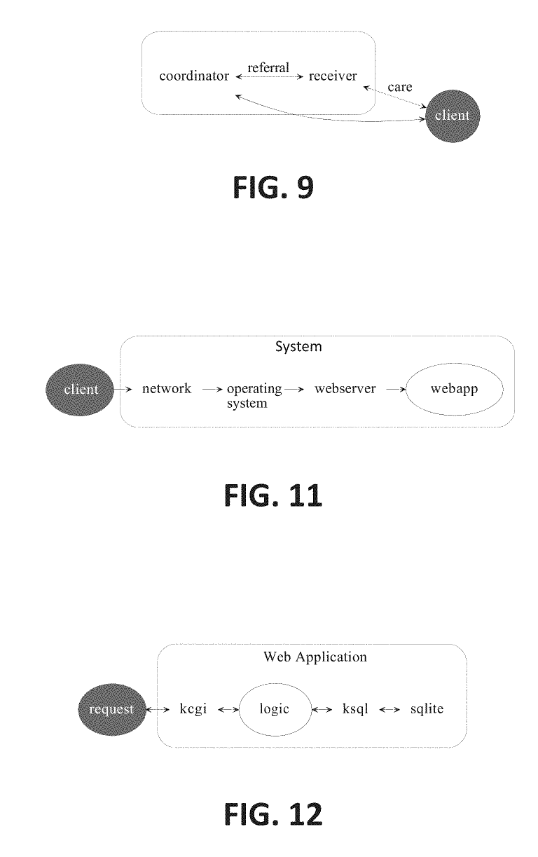

From a conceptual standpoint, with reference to FIG. 9, the system may be functionally separable into components for member agencies, clients, and administrators. Member agencies may be further separated into receiver and/or coordinator roles. The interaction between these components constitutes the system from a functional perspective. The system enables coordinated responses on the part of member agencies to clients. Coordinators accept clients and create or update client profiles including a risk assessment, then analyze the client profiles to determine the appropriate receiver agencies (a “referral”) for the client. In one aspect, the analysis may be assisted by one or more expert matching systems, including, but not limited to, systems implementing reinforcement learning, supervised learning, and other techniques in machine learning. Once referred, both coordinator and receiver agencies are able to collaborate on the client's care situation using the system, which is further managed by the receiver. The functionality of the system may thus be separated into as efficiently and securely maintaining a client record, matching a client record to receiving agencies, and referral collaboration. It should be understood that the receiving agencies may be external to the system, in which case the coordinator would need to update the client record (client scheduled, client attended, etc.) herself as the client receives services from the receiving agencies. Otherwise, an external receiver has the same facility in terms of referrals as a member agency receiver.

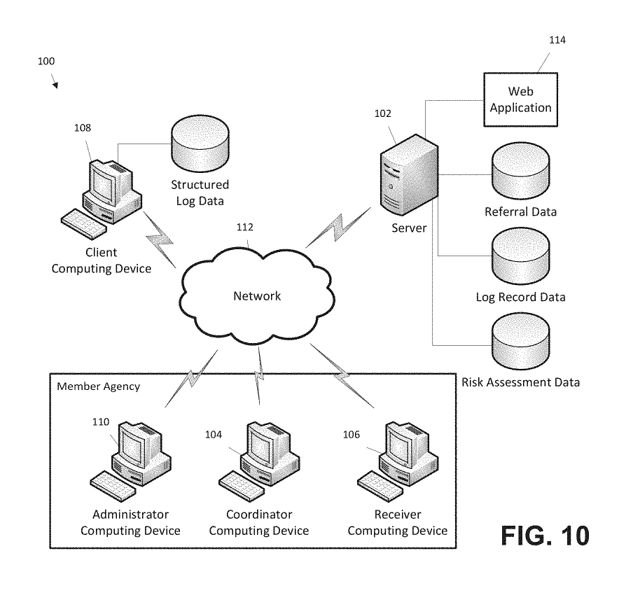

As best seen in FIG. 10, reference number 100 generally designates an exemplary computer-implemented system that may be used to implement aspects of the invention described herein. System 100 may include a server 102, a coordinator computing device 104, a receiver computing device 106, a client computing device 108, and an administrator computing device 110 in communication over a network 112. Network 112 may be any type of network, such as a wide area network or local area network that may allow for wired and/or wireless communication between server 102 and computing devices 104, 106, 108, 110. It should be understood that server 102 and computing devices 104, 106, 108, 110 may be a desktop computer, smartphone, tablet, or any other type of mobile computing device that includes a processor configured for implementing computer-executable instructions and methods as described herein. Server 102 may utilize an operating system that has security related features, such as, for example, Open BSD, as well as AES XTS 256 for full disk encryption. Further, remote access to the operating system in server 102 may be provided by OpenSSH.

In accordance with an aspect of the present invention, server 102 includes a processor and a memory having a computer application 114 comprising computer-executable instructions (such as, but not limited to, a web application) stored therein configured for performing, through the use of the processor, a number of steps that coordinate client referrals in view of a respective risk assessment document, as well as other functionality described herein. The description that follows describes the user roles, functions, and data involved in the system. In more systematic terms, software application 114 is configured for maintaining and collaborating upon a client's risk assessment document—an unambiguous, fixed-form document—for the care of the client. Software application 114 includes a front-end and back-end. Users (coordinators, etc.) operate the front-end, which exchanges data with the back-end. The front-end may be a browser interface, which must work on all relatively modern web browsers. It is a set of straightforward pages consisting of standards-compliant HTML5, JavaScript, CSS, images, and other common web technologies that are usable on the spectrum of common computing devices (mobile, desktop, etc.). The back-end will be a system running on server 102 and consist of source code, build infrastructure, and documentation for both of these components. Server 102 may comprise a single, well-maintained virtual machine, for example. It should be understood that at least a portion of the functionality described with respect to software application 114 may be executed remotely over network 112 by computing devices 104, 106, 108, 110 using a stand-alone or companion software application (e.g., mobile application) that is stored in the respective computing device 104, 106, 108, 110.

With reference to FIG. 11, software application 114 is accessible over network 112 utilizing an operating system and/or a web server, wherein client computing system 108 communicates with software application 114 using a web browser. Other non-web-application system components, such as domain-specific analytical tools, may also be used in conjunction with the system. With reference to FIG. 12, the computer-executable instructions included in the system are configured to accept HTTP requests and broker a response. Software application 114 may use some generally available components (kcgi, ksql, kwebapp, SQLite) to coordinate this response. These components collectively manage the bulk of the application logic to respond to requests, although this may change as the connective syntax grows with functionality. The utility of these components is specifically as follows:
kcgi: parsing the request, formatting response
ksql: database management
kwebapp: produces an API to interact with ksql and kcgi (instead of hard-coding SQL queries and such)
SQLite: database access

The kcgi and ksql libraries and kwebapp utility may be privately forked and extended to provide for specific features and/or environments. The first, kcgi, may be forked to capem_cgi to provide features for the specific network run-time environment. The ksql may be forked to capem_sql to provide support for specifically-installed SQLite extensions. Lastly, kwebapp may be extended to capem_webapp to support outputting into the extended library functions. The remaining parts of the application 114 (e.g., “business logic”) may be responsible for connecting requests to the appropriate functions that manage data. For instance, the logic of passing a request to update a client record, or create a risk assessment document, to the database routines enables those actions. The only exception to date is the referral algorithm that maps from a risk assessment document to a limited set of receiving agencies. At this time, the referral mapping uses an algorithm of having each question in the referral incrementally adding to one or more referral categories, with the final referral selecting from the top three category values. Software application 114 may further provide for intelligently matching risk assessments to receiving agencies (e.g., using statistical analysis), differential analysis of a client's record (log events, risk assessment document, etc.), and collective analysis of some or all of the information related to clients (e.g., to identify trends, etc.). In addition, software application 114 may provide for in-band collaboration between client, coordinator, and/or receiver computing devices using external systems (such as XMPP) or through internal use of a database. There also may be greater separation between client types, wherein referred client types are entered into the system by a coordinator, while unreferred clients are not. Moreover, clients may have the ability to change their status (from un-referred to referred) as they're brought into a home agency. In accordance with an aspect of the present invention, software application 114 may also provide for secure logging of personal data on the part of the client, which will be described in more detail below.

With reference to FIG. 10, system 100 involves coordinators, who orchestrate referrals using coordinator computing device 104; clients, who may provide the data for the risk assessment using client computing device 108; receivers, who may receive client referrals using receiver computing device 106; and administrators, who may manage all users using administrator computing device 110. This portion of the application describes the function of the roles in system 100. A role may correspond to a human operator (a “user”) of the respective computing device; however, in some cases, a role can be filled by an algorithmic component.

Users of system 100 are identified by an internal numeric designation that may be unique, and optionally an electronic communication device, such as but not limited to, an e-mail address, a phone number (for texting), and the like. It is preferred that no two roles share the same e-mail address or internal designation; however, all users can be provided the ability to change their e-mail addresses at any time. It is contemplated that the internal designation never changes. Clients may not be required to have an e-mail address, but preferably, all other user roles are. It is contemplated that multi-factor authentication (MFA) be used to confirm a user's the identity to protect against unauthorized access, and protect against the disclosure of client information stored in system 100.

Coordinators are one of the two main users of software application 114 in that they will spend the most time using system 100. Coordinators belong to a member agency. They are created and managed by an administrator utilizing administrator computing device 110. Any coordinators for a given member agency may interact with any clients assigned to that member agency. A coordinator may also be a receiver. If a coordinator wishes to exit system 100, an authorized administrator must deactivate him or her using administrator computing device 110.

The coordinator has a number of separate tasks that can be performed using coordinator computing device 104. One task is to create a client risk assessment document with direct input from a client. Once created, the coordinator will then verify that the pre-selected choices for receiving agencies are acceptable. Risk assessment documents may also be “updated,” which is equivalent in process to creation. By allowing for the risk assessment documents to be updated, system 100 provides a dynamic platform for modifying referrals based on updated client information which allows for an efficient delivery of services to meet the needs and goals of a client. Another task is to manage external receiving agency contacts following the risk assessment creation. Until the coordinator computing device 104 is used to acknowledge the receiving agency selection, these referral will be listed as “pending.” Coordinator computing device 104 may also be used to manage declined referrals from member receiving agencies, and respond to log events generated by the client using client computing system 108. This includes acknowledging the log event with a variety of response codes (e.g., “I will contact you”, “please contact us”, etc.). Until the acknowledgement by coordinator computing device 104, the log event is listed as pending. Coordinator computing device 104 may also be used to manage user accounts in the sense of passing notifications to software application 114 in the event of client death, client leaving the system, etc.

The pre-selected referral choices are determined by one of several techniques, or a combination of techniques. The simplest technique is weighted matching, which ranks applicable referral categories by associating risk assessment answers with weights. Another technique is to use machine learning: existing referrals may be analyzed over all clients and correlated with post-referral risk assessment changes, for example, reduction in symptoms after certain referrals. Similar risk assessments and client profiles may select from referrals with demonstrable prior efficacy. There are many other machine learning, artificial intelligence, and general statistical methods that may be used, alone or in combination, to suggest meaningful referrals.

A receiver is a member agency role like the coordinator. There is also the concept of an external receiving agency, which is different. External receiving agencies are not users of system 100, but are rather externally-referenced agencies and their affiliated individuals. Receivers in the non-external sense belong to a member agency. They are created and managed by administrator computing device 110. Any receiver computing device 106 for a given member agency may interact with any clients referred to them directly or through client computing device 108 through network 112. A receiver may also be a coordinator.

A receiver, in the member agency context, using receiver computing device 106 is able to receive referrals from coordinator computing device 104 over network 112. Receiver computing device 106 is configured to process incoming referrals, which may either be declined or accepted, and update the client's referral file with various pertinent information, such as that the client has attended a referral appointment, and possibly free-form notes on the referral actions taken.

A client is registered by a coordinator with software application 114 when their initial risk assessment is created. The client is thus associated with a member agency as the “home agency.” Part of the client's registration consists of information that may be used to allow the client to remotely log in (e.g., identifying e-mail address, password, etc.) to software application 114 using client computing device 108 over network 112. Client computing device 108 may access and use software application 114 to perform several functions independent of the coordinator, such as, to log or record “events,” wherein the logged events may be stored locally on customer computing device or in a database on server 102. Depending upon the log event, the coordinator may use coordinator computing device 104 to follow-up when acknowledging the client's pending log event. Client computing device 108 may also be used to display the client's receiving agencies and the status (contacted or not) of the coordinator's efforts to contact the agency, and display the status of the client's log message interaction with coordinators. It should be understood that a client need not be associated with any particular coordinator, nor is it required that the clients be able to contact coordinators or receivers directly via system 100.

It should be understood that system 100 need not be restricted to one single administrator having administrator computing device 110, but can be a set of computing devices with distinct roles. At least one administrator has the ability to delegate other administrators at all times. Those with this role may be considered “super administrators.” Separating roles protects system data by narrowing access of administrative features to specific administrators, which in turn protects the clients. Administrator functions may be fulfilled by one or more individuals or could be automated.

Delegation is performed by at least one administrator computing device 110. This may consist of assigning new administrators to roles or modifying existing roles. This is a security-sensitive role because it might expand the number of users with access to client data. In one version, newly-created administrators are not automatically set up to delegate; instead, this could be a manual change within the database. Administrator computing device 110 can also be used to create, modify or manage external receiver agencies, which will be minimally identified by a contact person, address, etc. External receiver agencies will be identified by one or more “tags,” which classify the agency in relation to the one or more risk categories that the external receiver agency is able to address. The same tags can be applied to receiver member agencies. Once created, external receiving agencies cannot be removed as they may already be linked to a risk assessment result; however, they may be disabled from future referrals. The tags describing an external receiving agency might also change: new tags may be added, and existing tags may be “retired”. A tag that is retired will not be used for future matching. To keep past matches coherent, referrals will have a monotonically increasing tag-version number, and each tag contains the version when it was added and removed. Additions or removals increment the version number.

System 100 may provide for any number of member agencies, and allow for the addition of a member agency, as well as suggest other member agencies (or external agencies), at any time. The administrative control for member agencies implemented using administrator computing device 110 may consist of the ability to add (or, in a constrained way, modify) member agency information. This management also includes member agency users: coordinators and receivers. In general, these are fixed individuals. However, software application 114 may allow for creating new users and, if necessary, disabling existing receiver accounts. A member agency user with a coordinator role is called a coordinator; a member agency user with a receiver role is a receiver. A user with both may be referred to as a receiving coordinator or coordinating receiver.

The client management role implemented using administrator computing device 110 allows for enabling and disabling clients in response to well-defined criteria: “bot” accounts, abusive behavior, etc. Beyond account-level criteria, the client manager will also need to respond to coordinator requests to invalidate clients in the event of death or exit from system 100. Lastly, clients may request to change their member agency upon the occurrence of an event (e.g., relocation).

It should be understood that member agencies are not users of the system 100, but are merely a logical structure for organizing coordinators and receivers. Each client is associated with a member agency. This is a mechanism to allow for the later dynamic addition of new member agencies to system 100. Member agencies are managed by an administrator. A member agency that is “receiving” has receiving clients registered as part of the agency. A member agency that is “coordinating” has coordinators. A member agency may be both receiving and coordinating—even if via a single client. A member agency must have at least one coordinator or receiver, or else it has no user representation. It is also contemplated that system 100 may provide one or more clients that are not associated with a member agency. These clients may only want the level of service and functionality provided by system 100 to all registered clients of system 100 regardless of their affiliation with a member agency. These type of services and functionality may include the ability to contact with peer-mentors, contact information related to member agencies in a given geographic region, and other services provided by system 100.

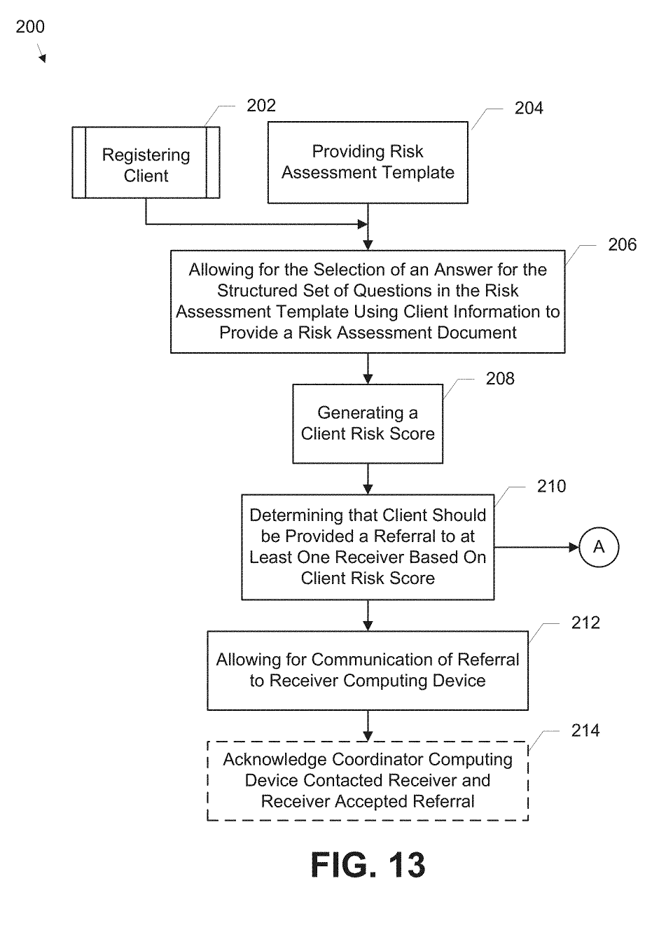

The above-referenced components of system 100 may be used to interact with certain data or information related to C4^{SM} concept previously described, namely, the risk assessment document, which is created (or non-destructively updated) by a coordinator with input from a client; the referral, which is managed by coordinators and receivers; and the log record, which is created by the client and managed by a coordinator. These one or more aspects of system 100 demonstrate the motivational nutriment of competence, which may be exemplified in the method 200 described below and shown in FIG. 13. In general, method 200 comprises a process of a risk assessment, which may include risk assessment questions, answers, generated risk scores, referral risk categories, and actual referrals for services.

With reference to FIGS. 10 and 13, method 200 includes a step 202 of registering a client using coordinator computing device 104. Method 200 also includes providing a risk assessment template that is stored in a memory of server 102, another memory store accessible over network 112, or locally in coordinator computing device 104, at step 204. A risk assessment template includes a structured set of indexed questions with a plurality of structured answers (e.g., two or more) for each question. It should be understood that the structured answers may be one or more of a numerical range, a numerical input, a defined value, a word (e.g., yes or no), or a phrase. The risk assessment template is fixed and cannot be changed dynamically. At step 206, coordinator computing device 104 may be used to access the risk assessment template, and enter, select, or otherwise provide an answer to each of the indexed questions included in the risk assessment template using information received from the client directly in-person by client or indirectly by client via telephone or other medium (i.e., client information) to generate or create a risk assessment document (e.g., digital file). The coordinator computing device 104 may be used to create the risk assessment document for clients belonging to the coordinator's member agency. The risk assessment document is preferably stored in a memory of server 102, for example, in a database that is always on an encrypted partition of the hard disc. The security of the risk assessment document is important in that it will enable the client to be open to answer the questions in the risk assessment template freely without the fear of their information being disclosed to third parties. The answers include information related to the client, which may relate to the services being requested or needed by the client. The structured questions may be guided by a coordinator, with input from the client; indirectly by the client and proxied by the coordinator; or directly by the client. Risk assessment documents are write-once: they are never updated in place, but rather copied into a new risk assessment document during each update. Therefore, the risk assessment document is read-only.

In another embodiment, method 200 may allow for the client to create a non-canonical risk assessment document that is copied by a coordinator, so that the coordinator can generate a canonical risk assessment document. The canonical risk assessment document may then be used to generate a client risk score for each risk category and decide whether to generate a referral for such risk category based on a reduction algorithm, as will be discussed below. Also, it is contemplated that the method of coordinators only being able to create risk assessment documents being guaranteed by role-based access control to the database. Clients, coordinators, and other relevant parties (e.g., auditors) may be able to access the risk assessment documents also by way of role-based access control. The role-based access may be managed by the database process, where the database process is not in the address space of the process assigning role. This way, a compromised front-end (e.g., web application) process may not alter the role after it is appropriately set.

At step 208, the method includes generating a client risk score using the selected structured answers provided for each of the structured set of questions included in the risk assessment document. A client risk score is a value describing an client's level of risk in a given risk category (e.g., mental health, sexual health, general health, housing conditions, etc.). For example, a risk score of 1.0 could be considered to be most at risk, and a risk score of 0.0 may be considered to be the degenerative no risk. As a further example, a risk score of 0.5 on the scale of mental health risk may be referred to as moderate risk, 0.25 to minimum risk, and so on. It should be understood that the unit interval values may correlate across risk categories, such that, for example, the risk score of 0.75 for mental health is considered greater than a risk of 0.5 for sexual health. Further, a non-answer to a structured question may be considered a valid (if degenerative) data point. It should be understood that each question and/or answer could be associated with one or more risk categories. Therefore, the number client risk scores that are generated for each question and/or answer will correspond to the number of risk categories are associated with the question and/or answer. Further, the client risk score may be associated with the risk assessment document and be non-destructively stored along with the risk assessment document in the memory of coordinator computing device 104.

The client risk score(s) may be produced by an algorithm embodied by executable computer instructions that map each of the structured questions (e.g., yes/no, numerical range, numerical input, defined value) in the risk assessment template into an ordered set of values, wherein the values may be arranged in unit intervals (e.g., whole numbers (1, 2, 3, 4, 5), decimals (0.5, 1.0, 1.5, 2.0, etc.), etc.). Each set element is a risk score and assigned to a risk category, for example, a risk score of 0.5 for the risk category mental health. An example of a question may be “how many days have you been ill in the last month,” with maximum 31, minimum (degenerative) 0. It is also contemplated that a question might map into more than one risk category, wherein the assigned risk score would apply to each of the mapped risk categories.

In one embodiment, the algorithm may statically map each possible answer to a structured question to applicable risk categories with a given weight. Given, for example, a question with answers yes/no/maybe and ordered values of 1.0, 0.0, and 0.5, respectively, the value would be multiplied a weight in the unit interval. The risk score for a given category is then the fraction of the computed amount over the maximum.

Next, the risk assessment data (client risk scores) obtained from the answers in the risk assessment document may be used to identify one or more receivers related to the relevant risk categories so that the client can be referred to them. This component operationalizes the motivational nutriment of competence by facilitating access to services within/between receivers, and operationalizes the motivational nutriment of relatedness because of the establishment of a personalizes client-centered network (based on the risk category referrals) from within a larger available network of receiver resources/services. The set of all receivers mapped from a client by their client risk scores in essence creates a “social network” of the client's care requirements, wherein the social network includes the client, coordinator, and identified receivers.

In one aspect, a matching algorithm may be used to identify the relevancy of a given receiver given client risk score in a risk assessment document. However, prior to actually identifying one or more receivers for a referral, it should be understood that method 200 may include step 210, where a reduction algorithm is used to determine if a referral should or should not be made. In one embodiment, the client risk scores selected for referral are simply a selection of the highest risk score values. This is possible given the consistency of the score value. For example, the client risk scores may be 0.8 for sexual health, 0.5 for isolation, and 0.1 for mental health, but the reduction algorithm may only choose the sexual health for purposes of making a referral to a receiver. In another embodiment, the client risk scores selected are all above a certain predetermined threshold. In yet another embodiment of this aspect of method 200, the many-to-many map of answers to client risk scores may be guided by a machine learning algorithm. The machine learning being trained iteratively by overridden values from the coordinator computing device. The machine learning algorithm would, in one embodiment, output the weights used for the static mapping. In another more robust non-linear algorithm, the machine learning algorithm would map directly from all possible answers into client risk scoring, bypassing the weights entirely. One example of the linear and non-linear machine learning being PCA (principal component analysis), which derives an optimal map from previous client risk scores, referrals, and overrides. The machine learning algorithm may further be trained for context, such as per municipality to capture local effects. It should also be understood that method 200 may allowing a coordinator to override the reduction algorithm with a custom set of referrals using coordinator computing device.

Method 200 may further include identifying at least one receiver to be included in the referral. It should be understood that a receiver that is included in a referral is associated with the risk category that correlates to the client risk score that prompted the generation of the referral. For example, if a client risk score is greater than a predetermined threshold, and the client risk score is related to the metal health risk category, then it follows that the at least one receiver that will be included in the referral will be associated with the metal health risk category. Further, the receiver may be identified using a diverse set of metrics, including, but not limited to, geographic location relative to the client and/or coordinator, capacity, facilities, historical trends (e.g., turn-around), etc. Also, the identification of the receiver(s) may be linked to the history of referrals from individuals' referred risk categories to the actual receiver and the status of the client with respect to their care. For example, in the event of a referral of clients to a receiver, whether individuals attended the referral appointment and carried through the course suggested by the receiver.

Also, method 200 may include other ways to select the at least one receiver to identify in a referral. For instance, an algorithm may be used to map from a client's referrals into a possibly-empty set of receivers. In one embodiment, the receivers are matched with individuals by a variety of static scores, and with a variety of tunable constraints: location-first, time-first, etc. It should be understood that the results of this algorithm are overridable by the coordinator computing device 104. In another embodiment, the algorithm employs machine learning to suggest receivers based upon the history of the receiver in the given risk category, the risk assessments for the referred individual, and the level of treatment sought (or goals set) and received (achieved) by the client. This captures biases on the part of the client, such as distance to the client's residence or workplace. Another embodiment uses the same methodology, but takes into consideration all clients being referred to the receiver. This captures the receiver's ability to handle certain client profiles better or worse. In other embodiments, the same methodology applies but also takes into effect coordinators' patterns of overriding for a given client and/or takes into account the receiver's capacity at given times.

A receiver, whether external or as a member agency, consists of identifying information (address, contact person, etc.) and a set of discrete markers. These markers are numeric, and may be mapped from a risk assessment document. As discussed above, receiving agencies are linked to clients by referrals, which are created by coordinator using method 200 and communicated to the receiver computing device 106 by the coordinator computing device 104 at step 212. Receiver computing device 106 may then be used to accept the referral that is communicated by coordinator computing device 104. The risk assessment document links or otherwise made available to the receiver agencies, whether as member agencies or external, with a referral.

A referral is associated with a status field provided by software application 114. At step 214, the coordinator may acknowledge that he or she has contacted the receiving agency using coordinator computing device 104 and that the receiver and/or receiver computing device 106 has accepted the referral before the referral relationship “completes.” In the case of member receiving agencies, this is accomplished in-band by the receiver. There also may 300 be a facility for controlling receiving agency access to client information in the event of a referral; for example, providing the receiver access to client records. This may be accomplished for external agencies with easy PDF generation of client data that may be distributed by e-mail or paper. PDFs may be password-protected as an additional security measure.

In further aspect, method 200 may also include steps to ensure the integrity of the risk assessment document and computed risk scores such that previous client risk scores may be verified and, if necessary, recomputed. This aspect includes distilling the risk assessment document into its component parts of answers to questions, and assuming that the risk assessment questions themselves are historically valid; distilling the risk scores into the unit interval values assigned by the algorithm; and distilling the reduced referrals into those suggested by the algorithm, and those overridden by the coordinator using coordinator computing device 104. The aspect further includes taking a data representation consisting of one or more of the above-referenced distilled items/values and transforming the data representation into a hash value. The data representation accounts for the last known risk assessment process, such that the hash incorporates the last hash, collectively establishing a hash chain. The hash chain (or just the last hash) is distributed or otherwise communicated to the client computing device 108 for storage in its memory, such that the client is able to affirm the integrity of the history of risk assessments. The hash value (or hash chain) is computed at the time that the (canonical) risk assessment document is submitted to the database for storage in the respective memory location.

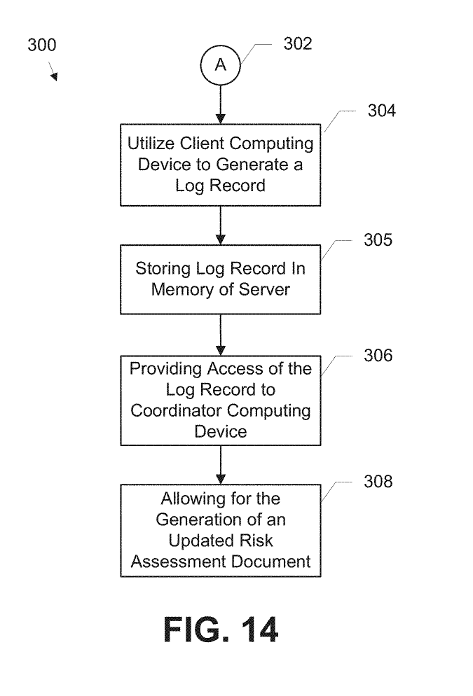

Further, an exemplary method 300 in accordance with another aspect of the present invention is shown in FIG. 14. In general, method 300 is used to allow the client to maintain contact with their coordinator through the use of log records, where the log records may affect current client risk scores. This method 300 embodies the relatedness concept by supporting continuity of communication between the client and the coordinator. In implementing method 300, as described above, it is presumed that coordinator computing device 104 has been utilized to create an initial risk assessment document, and a client risk score generated from the initial risk assessment document has been used to refer the client to at least one receiver, at step 302.

At step 304, log record may be generated or otherwise created by a client using client computing device 108 to reflect their current (updated) risk assessment profile. It is a way for the client to independently “follow up” on or update a prior risk assessment. However, this should not be confused with modifying the risk assessment document itself. This version of the log record may include two parts. One part of the log record may include updated client risk assessment information that may comprise answers to a preliminary set of “tracking” questions to generally identify client well-being. These questions are fixed and reflect the risk assessment template, in that the log record signifies a change in part of the risk assessment document. Another part of the log record may include a way to augment the risk assessment with new risk assessment points. In this way, a client can augment a standing risk assessment explicitly and/or implicitly with new points of interest, such as, but not limited to, symptom-based events. It should be understood that this type of log record can be stored in the memory of client computing device 108 and not shared with any third party, including coordinator computing device 104 or receiver computing device 106, so that the log record and the contents thereof can be collected and analyzed by the client. However, client may decide to communicate log record to server 102 over network 112 so the log record is stored in memory of server 102 at step 305. Further, access to this type of log record may be provided to coordinator computing device 104 and/or receiver computing device 106 by client computing device 108 so that the coordinator and/or receiver can help the client with the analysis. When the log record is stored in memory of client computing device 108, hash values may be used, as described above with respect to the risk assessment document, to maintain the integrity of the log record.

A log record can also be a request by client, using client computing device 108, to engage in further coordinator interaction (i.e., communication request). The request could be for an in-person interaction between the client and the coordinator, or the request could be for interaction between the client and the coordinator via telephone or using computing devices 104, 108. To facilitate the communication requested by the client in the log record, software application 114 may allow client computing device 108 to hold a two-way communication with one or more coordinator computing devices 104 at a member agency. This communication may include “short-message” asynchronous interaction between client computing device 108 and one or more coordinator computing devices 104, and might optionally consist of note-taking abilities for coordinators to maintain a log to share with other coordinators who participate in the exchange.

At step 306, access to the log record may be provided by server 102 to coordinator computing device 104 over network 112, and displayed and reviewed by a coordinator using coordinator computing device 104. Since system 100 provides for anonymity for a client, the log record may not include any information that may directly identify the client (client name, client e-mail address, etc.) to the coordinator. As such, for example, a unique identifier may be provided by a database rowed or random number generated by the system along with the log record, and the client would notify the coordinator of the unique identifier out-of-band so the coordinator can attribute the log record to that particular client. A coordinator may respond to a request included in the log record by communicating a response code to client computing device 108 over network 112 using coordinator computing device 104. Initially, the log record communicated to coordinator computing device 104 is simply marked as “delivered” and is displayed as such on client computing device 108. When a coordinator reads the log record, it is marked as “read.” Finally, the coordinator may mark the log record with status: pending; referral for the “log record” in process; or contact with receiving agency initiated, awaiting response. Every log record, upon being reviewed using a display of coordinator computing device 104, has a text input field for the coordinator to add notes. These notes may only be visible by coordinators.

The information included in the log record received by the coordinator computing device 104 (e.g., updated client risk assessment information, other information received from client computing device 108 during the two-way communication, etc.) may be used to generate an updated risk assessment document of the client, wherein the updated risk assessment document is prepared and stored using coordinator computing device 104 (while maintaining the integrity of the initial or previous risk assessment document), at step 308. This updated risk assessment document may provide the basis to modify an existing client risk score or create a new client risk score, which in turn may provide the basis for modifying the referral of the one or more receiver(s) to the client.

There may be instances where the receivers are not direct connected to the client by way of system 100. In this case, third-party institutions may be proxy entities managed by the coordinator in lieu of the receiver, with referrals and updates being proxied by the coordinator manually. It is contemplated herein that a proxied entity may be “upgraded” into a full member of system 100, with all current referrals being handed off to the new institution.

System 100 also provides a secure environment that allows for all participants to exchange the client data described herein. The security of system 100 accounts for access, modification and storage of the client data. With respect to all data being stored by a database, the database may be on an encrypted partition, or the database itself may be encrypted before being written to the memory. The storage of the risk assessment documents in a database may be on an encrypted partition of the memory of server 102. All access, whether by coordinators, clients, or receivers are defined by a role, and access may be granted or denied according to the role assigned to that party. For example, a receiver may be permitted to update the referral notes, but client may only be permitted to read those notes. Further, the role-based access may be managed by the database process, where the database process is not in the address space of the process assigning role. This way, a compromised front-end (e.g., web application) process may not alter the role after it is appropriately set.

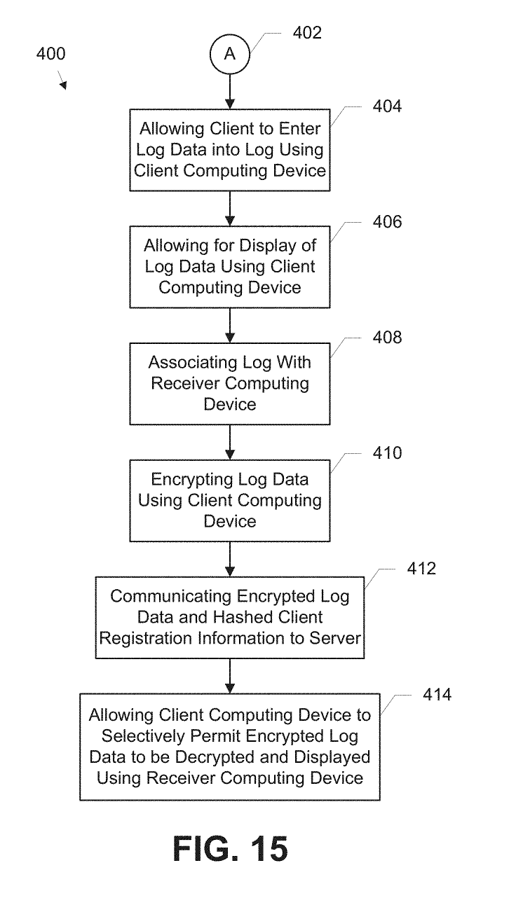

In another aspect of the present invention, software application 114 may include computer-executable instructions configured to perform a method 400 that allows a client to log structured and/or unstructured data (i.e., log data) into a digital log in an anonymous, private manner utilizing client computing device 108 (referred to herein as the “Tell Me” functionality), as seen in FIG. 15. This aspect further allows for the controlled exchange or viewing of the log data between peers (e.g., between client/receiver, practitioner/patient, etc.) without revealing the identity of the client that entered the log data. And lastly, it facilities guided analysis or self-analysis for a client. All of the log data managed by Tell Me is opaque from the perspective of system 100: both anonymity and privacy of the client and client data may be facilitated by in-browser or in-app technology. Thus, the provider of software application 114 does not know anything about the client that is logging data or the log data itself. The Tell Me functionality can be applied to many possible conditions, with the difference being the structure of the log data, and the availability of features such as the ability to self-monitor.

In order to illustrate the benefit of the Tell Me functionality provided herein, a few example scenarios are provided below. The first example relates to a stigmatized condition. Person 1 has been diagnosed with HIV and lives in a community that actively persecutes HIV+ individuals. Thus, her access to treatment is limited. Keeping a log of her symptoms is critical for the efficacy of her treatment; however, the existence of a log identifying Person 1 would put her at risk of harm. The Tell Me functionality allows her to keep a log of structured and/or unstructured log data—in this event, a record of her symptoms or instances of at-risk behavior—without fear of compromise. Person 1 is able to share the log with her practitioner (receiver computing device 106) remotely through system 100 using client computing device 108; and if the symptom trends are cause for concern, weigh the level of concern with the dangers inherent in Person 1 seeking treatment. Log structured data may include: incidences of at-risk behavior (unprotected sex, sharing needles, etc.), medication update changes (weight loss, non-adherence to medical schedule, change in body chemistry, etc.), symptoms (sores, heaving cough, temperature, etc.; duration; severity), related symptoms (depression, suicidal thoughts, etc.), and/or self-care (bed-rest, medication, etc.). If a practitioner is not available for remote consult, the structured nature of the data may allow Person 1 to self-monitor her own symptoms and observe trends in those symptoms. The Tell Me functionality may also allow Person 1 to store and review unstructured log data in the log. The unstructured data may be manipulated using algorithms or artificial intelligence to place such data in a format that allows for monitoring and analysis of Person 1 by the practitioner, as well as self-monitoring. Self-monitoring might show symptoms as trending toward outbreak.

Another example may relate to using the Tell Me functionality to log structured data relating to thought-impairing conditions. In this example, Person 2 has been diagnosed with bipolar disorder and occasionally lapses into psychotic episodes marked by paranoia. In non-psychotic episodes, Person 2's condition makes it difficult to self-evaluate (or describe) her condition. In psychotic episodes, her paranoia makes it difficult to trust traditional logging media (e.g., paper-and-pencil or a digital log). In this case, structured data might include: contributing factors (family pressure, interrupted routines, etc.), symptoms (hallucination, self-harm, delusions, etc.; duration; severity), and self-care (meditation, institutionalization, etc.). The features of Tell Me accommodate for both non-psychotic and psychotic symptom logging. By using structured data collection, Person 2 need not rely on abstract self-evaluation (“how do I feel?”). By using a system with well-defined and clear, unambiguous technologies and practices for anonymity and privacy, her paranoia may have less influence. In this case, self-monitoring is not a desirable feature: it might encourage falsification (to “buck a trend”) or exasperate symptoms of obsession, compulsion, or “log addiction.” In examining Person 2's log, a practitioner might, for example, study the effects of anti-psychotic medication. The practitioner might be able to see, by charting log instances that one type of anti-psychotic might result in significantly lesser instances of psychosis, while another might accomplish the same, but with the side-effects of disturbed sleeping patterns and emotional detachment. Since anti-psychotic medications can take on the order of weeks to take effect, long-term journaling is necessary to properly study results.

The foundation of the Tell Me functionality is in the utility of a structured digital log. The structured digital log is an unambiguous record of symptoms augmented by well-known conditions and corresponding recovery. By way of example, a condition that might contribute to psychotic tendencies may be an interrupted medication schedule. A symptom may be a set of hostile behavior, auditory hallucinations, and emotional detachment. Recovery, once the episode has passed (or to facilitate its passage), might be medication, cold compress, and breathing exercises. By way of another example, a condition might be lapses from a PrEP schedule or other physiological conditions affecting absorption (bulimia, hormone changes, etc.). A symptom might be fever or ulcers. A recovery step might be bed-rest or fever medication. By being able to independently log conditions, symptoms, and recoveries, a client can in time create a profile correlating the three. When viewed by a practitioner skilled in the process of correlating, the log is an invaluable tool for creating a stable treatment plan.

The anonymity and privacy functionality of Tell Me is what makes the above-described principles practical. Without anonymity, individuals suffering from stigmatized conditions might avoid keeping an identifiable log. Without privacy, individuals suffering from thought-impairment conditions might not trust the log medium. There are situations where a symptom log message is necessarily personal and thus ambiguous. For example, there is a clinical difference between a visual hallucination having a “negative” and a “positive” meaning. Thus, Tell Me differentiates the two during logging. It's assumed that the receiver (practitioner) is skilled in properly understanding what an individual logging client might interpret as a “negative” symptom. In other words, this is a tool ideally to be used by a receiver and a client (e.g., practitioner and a logger), unless self-monitoring is completely unambiguous. Lastly, practitioner-guided analysis (possibly with self-monitoring in the interim) lifts the set of conditions, symptoms, and recovery steps into an efficient treatment plan. The efficacy of said treatment plan can further be analyzed as it affects further symptoms.

The Tell Me functionality is particularly relevant and useful to logging for mental illnesses or any other risk category. For example, a client may use client computing device 108 to sign up to use software application 114 with a username and password. Before being sent to server 102 for registration, both the username and password are scrambled (“hashed registration information”) using the client computing device so that their original contents are obfuscated prior to being stored in the memory of server 102. The username and password may be salted with the client's birthdate or a value stored on server 102, if appropriate, to protect against rainbow table attacks. This protects the identity of clients who might otherwise use identifiable information (e.g., e-mail address) as a username. Once registered, a client may login to software application 114 with access to Tell Me. Again, the client's credentials may be scrambled prior to being transmitted to server 102. Once the login is negotiated, the user's password is retained within the browser session.

Once logged in to software application 114, client may then begin to enter log data (i.e., journal data) into a log, wherein the log data may include a log message or log event. In general, the content of the log data may relate to information contained in the client's risk assessment document. Log messages may be structured like a tree: the log message begins with a high-level statement (e.g., “my routine was disturbed,” “I had a hallucination”). With each selection, branches in the tree are followed (“my medication routine,” “my eating routine;” “an auditory hallucination,” “a visual hallucination,” etc.). At any point, a client may indicate that they no longer wish to be more specific, or outright cancel the log message. In many cases, the leaf of the tree is one of severity and/or duration. A completed log message (whether cancelled, filled to completion, or partially filled) may be followed by recovery steps. Recovery steps consist of a list of possibilities.

When the client uses client computing device 108 to fill in or enter their log with log data, which may be defined as a JavaScript Object Notation (JSON) structure recognized by browser JavaScript code, the log is updated, symmetrically encrypted using the client's password, then transmitted to server 102 in encrypted form along with a hash of the registration data. This way, server 102 does not retain the client's login name, original password, or log data. Server 102 may append information onto the log data such as timestamps. Client may also be given the option to store the log data locally in a memory of client computing device 108. For any given logging session, the client may enter as many log messages as they wish. To encourage regular logging, the client may sign up for e-mailed log messages. The identifiable request for a reminder is not coupled to a client.

In some instances, the client is able to self-monitor. This would involve an in-browser (or in-app) process of allowing for the display of the log data on a display of client computing device 108 at so the log data can be examined for trends or other self-monitoring facilities. At any point, the client may also wish to communicate or share all or a portion of the log data to a receiver computing device 106 (e.g., patient sharing log data with a practitioner) over network 112. First, the client must associate their log with the receiver computing device 106, who is identified, for example, by e-mail. If not part of system 100, the receiver is e-mailed that they have been added; if already participating, an e-mail is sent to receiver computing device 106 indicating that a new association has been made with a client. However, associations are not necessarily identified: it is the responsibility of the client to contact the receiver out-of-band (i.e., not through system 100) and apprise receiver of the association, for example, by providing the receiver with a unique identifier that is associated with the client's log to provide receiver the ability to identify the client's log in an anonymous manner. Once associated, a receiver is able to, for example, display and/or create a record of the client's logged medications. However, the client could choose to not grant the receiver access to view all of the client's log data, some of which may be private to the client.

In view of the above, and with reference to FIG. 15, exemplary method 400 may include the following steps that may be performed subsequent to a client being associated with a receiver based on a risk assessment document, as previously described, in step 402. Method 400 includes allowing the client to enter log data into a log using client computing device 108 at step 404, wherein the log data is related to information contained the risk assessment document. At step 406, the method includes allowing for the display of the log data on a display of client computing system 108, and associating the log with receiver computing device 106 at step 408. Next, the log data is encrypted using client computing device 108 at step 410, and communicated along with the hashed client registration information from client computing device 108 to server 102 over network 112 at step 412, wherein the encrypted log data and hashed client registration information is stored in a memory of server 102, Further, at step 414, client computing device 108 is allowed to selectively permit at least a portion of the encrypted log data to be decrypted and displayed on a display of receiver computing device 106.

The client may provide receiver computing device 106 with access to log data to receiver in other ways. One method is “in person,” where the client physically enters their password on the receiver computing device 106 when the receiver is logged-in to software application 114 using the receiver's log in credentials. This is deemed “explicit consent,” as the client must be physically present. In another method, using software application 114, the client may seal a “stored log” for receiver by a process of downloading all log data to client computing device 108, decrypts the log data on client computing device 108, re-encrypts the log data with a new shared username and/or password, and stores the re-encrypted data on server 102 for access by receiver computing device 106. Client communicates the shared username and/or password to the receiver out-of-band to protect the inadvertent disclosure of the username and/or password, and then receiver computing device 106 is used to access the log data stored on server 102.

Once access has been granted to receiver using receiver computing device 106, the receiver may be able to analyze and/or download all or some of the log data. After the respective log data has been downloaded and decrypted, the username and/or password provided to receiver may be discarded or otherwise deactivated by software application 114 to provide a one-time use. Thus, refreshing the browser window (or restarting the application) requires consent to be re-granted to receiver from client. It is also contemplated that the username and/or password be set to expire after a predetermined time period so that stale usernames/passwords are discarded. Further, it should be understood that, at any time, the client may revoke the association with the receiver, terminating implicit consent and disallowing the receiver from reviewing the client's log record in any way.

If the client wishes to change his or her password, all log data must be downloaded from server 102, re-encrypted, and re-uploaded to server 102. To preserve log data integrity, the hashes are compared when replacement log data is uploaded; however, since the hash is computed off-server 102, it can be faked with any conformant marker. This is only for the convenience of the client, however, and to make manual changes difficult for the operator.

In some circumstances, anonymity and strong privacy may not always be applicable or important to a client. For example, in some cases, a client may wish to have the ability to reset his or her password, which would require the log data to be unencrypted.

Other aspects of the Tell Me functionality are also contemplated. In one instance, the log messages or log events may be configurable so that system 100 may be used for different conditions. This could be on a per-logger basis (different people having different symptoms for the same condition) as well as between conditions. Further, one iteration of Tell Me used for mental health allows charting conditions, symptoms, and recovery over time. While useful when compared against a baseline schedule for medication, it is difficult to illuminate the effects of medication or the relationship between conditions, symptoms, and recovery. One analytical tool is to create an “analysis matrix.” Such a matrix could list log events on vertical and horizontal axes of a graph. For each cell connecting log events, the matrix would show the number of incident pairs within a given time. For example, this would show, within a given time frame, all pairs of conditions of not taking medication and symptoms of psychosis. This would assist a practitioner in understanding which conditions have the most significant affect on which symptoms. For example, since some medications are only absorbed while eating, a change in eating routine might show a subsequent increase of hallucination.

The system 100 is configured for getting to know the client and learning, responding to, and predicting preferences. Nonetheless, the motivational nutriment of autonomy is maintained by way of the client's ability reject a referral (altogether) or to reject referral to a specific receiver. Autonomy is further maintained by the coordinators ability to override the risk score-based referral on behalf of the client. The changes to the “social network” are responsive to all participants of the system 10, or it's not really a network. In view of the above, it can be seen that a client's risk scores may change, but receivers can also change, and even coordinators can decide themselves to trigger changes based upon their knowledge of the client The method described herein for continuously updating an client's social network in response to changes in the client risk scores, changes in the social network's connections (increased/decreased capacity, new facilities, new receivers, etc.), or changes as stipulated by the coordinator. Therefore, there may be updates that trigger a new set of connections, possibly enlarging or shrinking the client's social network. For example, the addition of new receiver, or loci of care, may result in the notification to coordinators of applicable client(s) that better referrals may be in order. The method may be implemented by a passive algorithm that constantly tests clients' assignments to receivers as new receivers are added or existing ones removed, and with significant changes that benefit the client triggering notification to the coordinator.

Having described various embodiments of the system 100 and associated methods, an exemplary computer environment for implementing the above-referenced functionality is presented next.

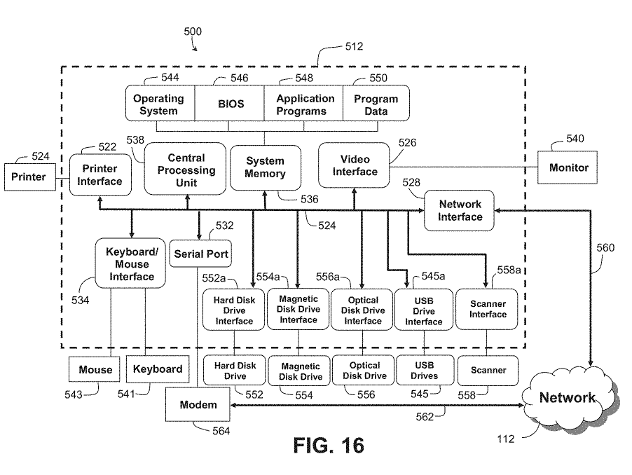

FIG. 16 shows an exemplary computing environment 500 that may be used to implement any of the processing of computer-executable instructions thus far described. Computing environment 500 may be a computer 512 that is representative of server 102, coordinator computing device 104, receiver computing device 106, client computing device 108, or administrator computing device 110. For example, computer 512 may include a system bus 524 that couples a video interface 526, network interface 528, one or more serial ports 532, a keyboard/mouse interface 534, and a system memory 536 to a Central Processing Unit (CPU) 538. A monitor or display 540 is connected to bus 524 by video interface 526 and provides the user with a graphical user interface to perform all of the relevant functionality described above. The graphical user interface allows the user to enter commands and information into computer 512 using a keyboard 541 and a user interface selection device 543, such as a mouse, touch screen or other pointing device. Keyboard 541 and user interface selection device are connected to bus 524 through keyboard/mouse interface 534. Display 540 and user interface selection device 543 are used in combination to form the graphical user interface which may allow the user to implement at least a portion of the processes described above with software application 114. Other peripheral devices may be connected to computer through serial port 532 or universal serial bus (USB) drives 545 to transfer information to and from computer 512.

The system memory 536 is also connected to bus 524 and may include read only memory (ROM), random access memory (RAM), an operating system 544, a basic input/output system (BIOS) 546, application programs 548 and program data 550. The computer 512 may further include a hard disk drive 552 for reading from and writing to a hard disk, a magnetic disk drive 554 for reading from and writing to a removable magnetic disk (e.g., floppy disk), and an optical disk drive 556 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media xD card), and a scanner 558. A hard disk interface 552a, magnetic disk drive interface 554a, an optical drive interface 556a, a USB drive interface 545a, and a scanner interface 558a operate to connect bus 524 to hard disk drive 552, magnetic disk drive 554, optical disk drive 556, USB drive 545 and a scanner 558, respectively. Each of these drive components and their associated computer-readable media may provide computer 512 with non-volatile storage of computer-readable instruction, program modules, data structures, application programs, an operating system, and other data for the computer 512. In addition, it will be understood that computer 512 may also utilize other types of computer-readable media in addition to those types set forth herein, such as digital video disks, random access memory, read only memory, other types of flash memory cards, magnetic cassettes, and the like.

As mentioned above, software application 114 may be implemented in a networked environment using logical connections to establish communication between server 102, coordinator computing device 104, receiver computing device 106, client computing device 108 and/or administrator computing device 110, as previously described. Network interface 528 provides a communication path 560 between bus 524 and network 112, which allows the instructions, modules, data, sequences, files, designations, notifications, or information described above to be communicated through network 112 between server 102, coordinator computing device 104, receiver computing device 106, client computing device 108 and/or administrator computing device 110 using computer 512, as described above. This type of logical network connection is commonly used in conjunction with a local area network (LAN). The instructions, modules, data, sequences, files, designations, notifications, or information may also be communicated from bus 524 through a communication path 562 to network 112 using serial port 532 and a modem 564. Using a modem connection is commonly used in conjunction with a wide area network (WAN). It will be appreciated that the network connections shown herein are merely exemplary, and it is within the scope of the present invention to use other types of network connections between server 102, coordinator computing device 104, receiver computing device 106, client computing device 108 and/or administrator computing device 110 including both wired and wireless connections.

From the foregoing, it will be seen that this invention is one well adapted to attain all the ends and objects hereinabove set forth together with other advantages which are obvious and which are inherent to the system and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement. Further, it should be understood that the use of the terms “module” and “component” herein are interchangeable and shall have the same meaning.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A method programmed for execution in a computing environment for facilitating competence support for a client to meet a goal of the client, utilizing a processor the method comprises:
providing a risk assessment template stored in a memory, wherein the risk assessment template includes a structured set of questions, wherein each of the structured set of questions includes a plurality of structured answers, and wherein the structured set of questions correspond to at least one risk category;
allowing for the selection of one of the plurality of structured answers for each of the structured set of questions in the risk assessment template using client information to provide a risk assessment document, wherein the selection of the one of the plurality of structured answers is provided by at least one of a coordinator computing device;
generating a client risk score based upon at least one of the selected structured answers provided for the structured set of questions included in the risk assessment document;
determining that the client should be provided a referral to at least one receiver based on the generated client risk score; and
allowing for the communication of the referral from the coordinator computing device to a receiver computing device associated with the at least one receiver, wherein the at least one receiver is associated with the at least one risk category.

2. A method in accordance with claim 1, wherein the risk assessment template is stored in the memory of at least one of the coordinator computing device or a server in communication with the coordinator computing device over a network.

3. A method in accordance with claim 1, wherein the risk assessment template is fixed.

4. A method in accordance with claim 1, wherein each of the plurality of structured answers is at least one of a numerical range, a numerical input, a defined value, a word, or a phrase.

5. A method in accordance with claim 4, wherein each of the plurality of structured answers is mapped to an ordered set of values.

6. A method in accordance with claim 5, wherein the ordered set of values are arranged in unit intervals.

7. A method in accordance with claim 6, wherein at least one of the structured set of questions corresponds to a plurality of different risk categories.

8. A method in accordance with claim 7, wherein the unit intervals are correlated across the plurality of different risk categories.

9. A method in accordance with claim 7, wherein the risk categories include one or more of mental health, sexual health, general health, general medical, housing conditions, living and accommodation, employment, finances, transportation, substance abuse, injection behavior, isolation and social status, or legal issues.

10. A method in accordance with claim 1, wherein the at least one risk category includes mental health, sexual health, general health, general medical, housing conditions, living and accommodation, employment, finances, transportation, substance abuse, injection behavior, isolation and social status, or legal issues.

11. A method in accordance with claim 1, wherein it is determined that the client should be provided a referral to at least one receiver when the client risk score is above a predetermined threshold.

12. A method in accordance with claim 1, wherein the identification of the at least one receiver is made based on the highest client risk score included in the risk assessment document.

13. A method in accordance with claim 1, further including the step of allowing for the coordinator computing device to be used to acknowledge acceptance of referral from receiver computing device.

14. A method in accordance with claim 1, further including the step of identifying the at least one receiver included in the referral based on at least one of geographic location, capacity, facilities, and historical trends of the at least one receiver.

15. A method in accordance with claim 1, wherein the risk assessment document is stored in a memory of a server in communication with the coordinator computing device over a network.

16. A method in accordance with claim 15, wherein the risk assessment document is read-only.

17. A method in accordance with claim 1, wherein the method further comprises the steps of:
generating a hash value utilizing a data representation of the selected one of the plurality of structured answers for each of the structured set of questions, the generated client risk score, and the referral;
communicating the hash value to a client computing device; and
storing the hash value in a memory of the client computing device.

18. A system that operates to perform the steps set forth in claim 1.

19. A method programmed for execution in a computing environment for facilitating and supporting communication between a client and a coordinator within a social network, utilizing a processor the method comprises:
providing a client computing device associated with a client;
providing a coordinator computing device associated with a coordinator, wherein the coordinator computing device includes a memory and is in communication with the client computing device over a network, wherein the coordinator computing device is utilized to create an initial risk assessment document using client risk assessment information, wherein the initial risk assessment document is stored in a memory of a server in communication with the coordinator computing device over the network, and wherein the initial risk assessment document is used to generate a referral including an identification of at least one receiver;
utilizing the client computing device to generate a log record, wherein the log record includes at least one of updated client risk assessment information or a request to communicate with the coordinator computing device;
providing the coordinating computing device with access to the log record over the network; and
allowing for the generation of an updated risk assessment document by the coordinator computing device based at least in part on the log record, wherein the updated risk assessment document is stored in the memory of the server, and wherein the updated risk assessment document is utilized to modify the referral.

20. A method in accordance with claim 19, wherein the memory of the server includes an encrypted partition, and wherein the initial risk assessment document is stored in a database in the encrypted partition.

21. A method in accordance with claim 20, wherein the memory of the server includes an encrypted partition, and wherein the updated risk assessment document is stored in a database in the encrypted partition.

22. A method in accordance with claim 19, wherein the storing of the initial risk assessment document in the memory of the server includes:
providing the initial risk assessment document in a database;
encrypting the database; and
storing the database in the memory of the server.

23. A method in accordance with claim 19, wherein modifying the referral includes adding one or more receivers to the an identification of at least one receiver.

24. A method in accordance with claim 19, wherein the at least one receiver includes a first receiver and a second receiver, and wherein modifying the referral includes removing one of the first receiver or the second receiver from the referral.

25. A method in accordance with claim 19, further comprising the step of storing the log record in the memory of the server prior to the step of providing the coordinating computing device with access to the log record.

26. A system that operates to perform the steps set forth in claim 19.

27. A method programmed for execution in a computing environment allowing for anonymous and private communication of log data associated with a risk assessment from a client to a receiver in the context of evidence-based practices, the method comprising:
providing a risk assessment template stored in a memory;
allowing the risk assessment template to be completed using client information entered using a coordinator computing device, wherein the completed risk assessment template is a risk assessment document stored in a memory of a server, wherein the server is in communication with the coordinator computing device over a network;
associating a client with a receiver based on the risk assessment document, wherein the client is associated with a client computing device;
allowing the client to enter log data into a log using the client computing device, wherein the log data is related to information contained the risk assessment document;
allowing for the display of the log data on a display of the client computing system;
associating the log with a receiver computing device, wherein the receiver computing device is associated with the receiver;
encrypting the log data using the client computing device;
communicating the encrypted log data and hashed client registration information from the client computing device to the server over the network, wherein the encrypted log data and hashed client registration information is stored in the memory of the server; and
allowing the client computing device to selectively permit at least a portion of the encrypted log data to be decrypted and displayed on a display of the receiver computing device.

28. A method in accordance with claim 27, wherein the risk assessment template is stored in the memory of the server.

29. A method in accordance with claim 27, wherein the risk assessment template is fixed.

30. A method in accordance with claim 27, wherein the encrypted log data is stored in a memory of the client computing device.

31. A method in accordance with claim 27, wherein the log data is structured log data.

32. A method in accordance with claim 31, wherein the log data is at least one of a log message or a log event.

33. A method in accordance with claim 27, wherein a time stamp is appended to the log data when stored in the memory of the server.

34. A system that operates to perform the steps set forth in claim 27.
